(19) United States
(12) Patent Application Publication
(10) Pub. No.: US 2025/0070387 A1
(43) Pub. Date: Feb. 27, 2025

(54) STRUCTURAL COMPRESSION PADS FOR BATTERY PACK FOR ELECTRIFIED VEHICLE

(71) Applicant: FCA US LLC, Auburn Hills, MI (US)

(72) Inventor: Tae Hyun Kim, Troy, MI (US)

(21) Appl. No.: 18/453,421

(22) Filed: Aug. 22, 2023

(51) Int. Cl. H01M 50/449; H01M 10/04; H01M 50/414; H01M 50/463

(52) U.S. Cl. CPC H01M 50/449; H01M 10/0468; H01M 50/414; H01M 50/463; H01M 2220/20

(57) ABSTRACT

A battery pack assembly for an electrified vehicle includes a first battery cell, a second battery cell and a first spacer disposed intermediate the first and second battery cells. The first spacer includes a first layer of material disposed between a first and second backing plate. The first layer of material defines a plurality of passages formed therein having a first geometric shape. The first layer of material is formed of a first polymer. A first plurality of filler members are disposed within the respective plurality of passages and define a second geometric shape. The plurality of filler members are formed of a second polymer. The first and second polymers are distinct.

### FIELD

The present application generally relates to electrified vehicles and, more particularly, to a battery pack incorporating structural compression pads between adjacent cells.

### BACKGROUND

An electrified vehicle (hybrid electric, plug-in hybrid electric, range-extended electric, battery electric, etc.) includes at least one battery system and at least one electric motor. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor.

The high voltage battery system generally includes a battery pack assembly that includes a housing that houses one or more battery packs. Typically, the battery pack assembly includes a cooling system wherein a cooling liquid is circulated along a cooling plate for cooling the battery packs and the battery pack assembly. Battery cells in the battery pack undergo changes in their thickness due to various factors including battery charging, discharging and aging. Battery cells additionally require some level of compression in the cell stack in order to maintain cell capacity and to keep the electrode layers intact throughout their life. It can be challenging to manage the cell stack compression in the battery pack assembly while accommodating such physical changes. Accordingly, while such conventional battery pack assemblies do work well for their intended purpose, there exists an opportunity for improvement in the relevant art.

### SUMMARY

According to one example aspect of the invention, a battery module for an electrified vehicle includes a first battery cell, a second battery cell and a first spacer disposed intermediate the first and second battery cells. The first spacer includes a first layer of material disposed between a first and second backing plate. The first layer of material defines a plurality of passages formed therein having a first geometric shape. The first layer of material is formed of a first polymer. A first plurality of filler members are disposed within the respective plurality of passages and define a second geometric shape. The plurality of filler members are formed of a second polymer. The first and second polymers are distinct.

In some implementations, the first geometric shape includes a cylindrical bore and the second geometric shape comprises a cylinder. The first spacer is configured to compress between the first and second cells whereby a stress-strain curve presents a substantial plateau section. In examples, the substantial plateau section represents a stress substantially between 1 MPa and 1.5 MPa and a strain substantially between 20% and 50%.

According to another example aspect of the invention, at least one of the first and second polymer comprises polyurethane or silicone. The first and second backing plates are formed of one of a polymer and an alloy.

In some implementations, the first geometric shape comprises at least one of an ellipse, oval, triangle, rectangle, octagon, pentagon or combinations thereof.

A battery module for an electrified vehicle according to additional examples of the present disclosure includes a first battery cell, a second battery cell and a first spacer disposed intermediate the first and second battery cells. The first spacer includes a plurality of filler members disposed between a first and second backing plate. The plurality of filler members defining a first shape and formed of a first polymer.

In additional arrangements the plurality of filler members are arranged in an offset configuration wherein first filler members of a first layer of the plurality of filler members alternatively locate between complementary second filler members of a second layer of the plurality of filler members during compression of the first spacer.

According to another example aspect of the invention, the plurality of filler members are arranged in an opposing configuration wherein first filler members of a first layer of the plurality of filler members compress directly against complementary second filler members of a second layer of the plurality of filler members during compression of the first spacer.

In some implementations, the first geometric shape comprises one of a cylinder, an oval and a trapezoid. The first spacer is configured to compress between the first and second cells whereby a stress-strain curve presents a substantial plateau section. In examples, the substantial plateau section represents a stress substantially between 1 MPa and 1.5 MPa and a strain substantially between 20% and 50%. The first polymer comprises one of polyurethane and silicone. The first and second backing plates are formed of one of a polymer and an alloy.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having a battery system including a battery pack assembly according to the principles of the present application;

FIG. 2 is an exemplary exploded perspective view of a battery module of the battery system of FIG. 1 according to the principles of the present application;

FIG. 3 is a stress strain plot showing various polymer materials used for conventional compression pads including a plot showing an exemplary curve having an extended plateau section resulting from a compression spacer constructed according to the principles of the present application;

FIG. 4A is a sectional view of an exemplary spacer constructed according to some the principles of the present application;

FIG. 4B is a sectional view of an exemplary spacer constructed according to additional principles of the present application;

FIG. 5A is a sectional view of an exemplary spacer constructed according to additional principles of the present application;

FIG. 5B is a sectional view of an exemplary spacer constructed according to additional principles of the present application;

FIG. 5C is a sectional view of an exemplary spacer constructed according to additional principles of the present application;

FIG. 6A is a detail view an exemplary spacer showing it partially compressed according to principles of the present application;

FIG. 6B is a detail view an exemplary spacer showing it partially compressed according to additional principles of the present application; and

FIG. 6C is a detail view an exemplary spacer showing it partially compressed according to additional principles of the present application.

### DESCRIPTION

As discussed above, a high voltage battery system generally includes a battery pack assembly that includes a housing that houses one or more battery packs. Typically, the battery pack assembly includes a cooling system wherein a cooling liquid is circulated along a cooling plate for cooling the battery packs and the battery pack assembly. Battery cells in the battery pack undergo changes in their thickness due to various factors including battery charging, discharging and aging. Battery cells additionally require some level of compression in the cell stack in order to maintain cell capacity and to keep the electrode layers intact throughout their life. It can be challenging to manage the cell stack compression in the battery pack assembly while accommodating such physical changes.

Accordingly, the present disclosure provides several spacer designs that satisfy various stress-strain characteristics needed between cells to manage their compression and swelling requirements for different application needs. The stress-strain curves (explained below with respect to FIG. 3) typically provided by conventional compression spacers are substantially linear. When making various changes to material characteristics such as, but not limited to, density, stiffness and hardness to conventional spacers, the stress-strain curve can shift up, down or left, right. In general however, such changes will not modify the shape of the stress-strain curve. The instant disclosure provides various examples where a structural element allows multiple material characteristics that can be combined with the structural behavior to tune the stress-strain curve to satisfy a particular requirement for various applications. Various combinations of material and structural shape and patterns are provided as a means to optimize the compression pad characteristics desired for different needs of the battery cell type.

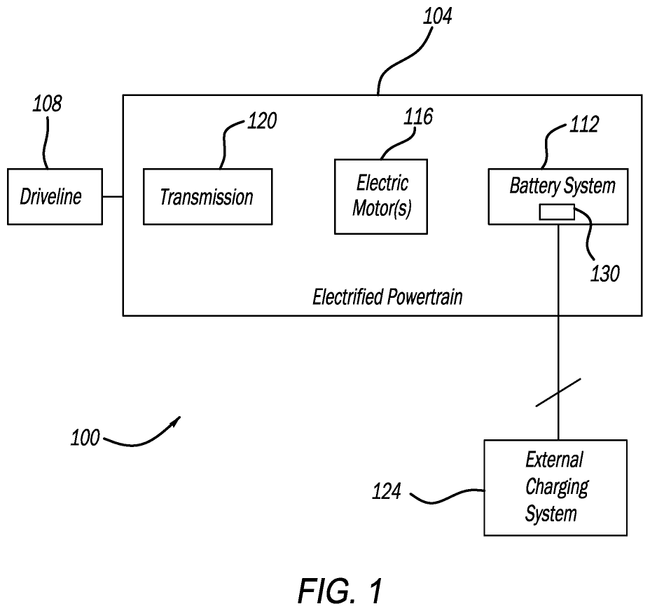

Referring now to FIG. 1, a functional block diagram of an example electrified vehicle 100 (also referred to herein as “vehicle 100”) according to the principles of the present application is illustrated. The vehicle 100 includes an electrified powertrain 104 configured to generate and transfer drive torque to a driveline 108 of the vehicle 100 for propulsion. The electrified powertrain 104 generally comprises a high voltage battery system 112 (also referred to herein as “battery system 112”), one or more electric motors 116, and a transmission 120. The battery system 112 is selectively connectable (e.g., by the driver) to an external charging system 124 (also referred to herein as “charger 124”) for charging of the battery system 112. The battery system 112 includes at least one battery pack assembly 130.

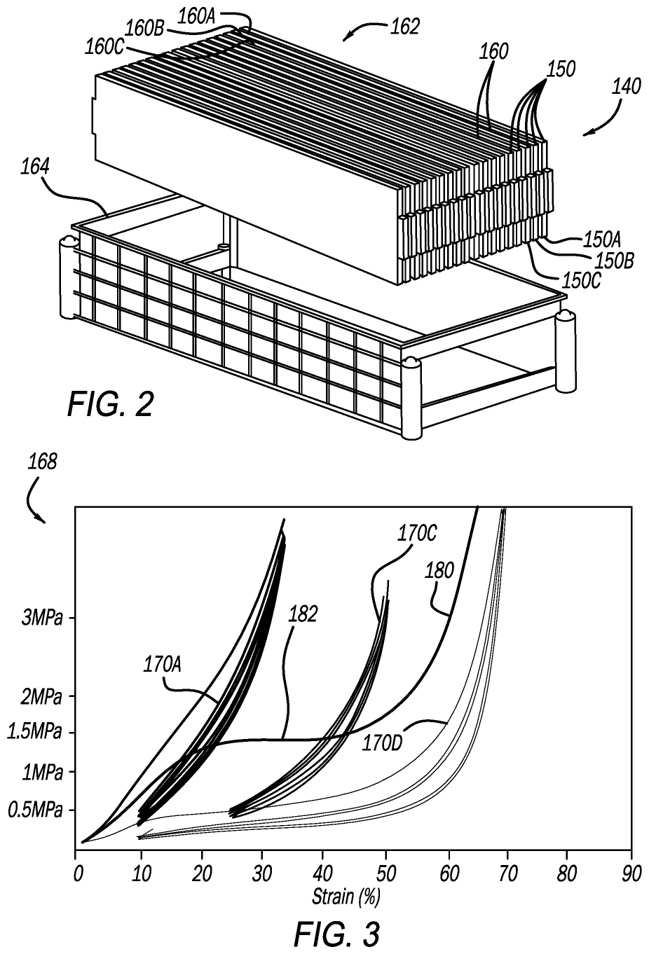

Referring now to FIGS. 2-6C, additional features of the instant battery pack assembly 130 will be described. In examples, the battery pack assembly 130 can comprise a plurality of battery modules, such as battery module 140 (FIG. 2). The exemplary battery module 140 includes a plurality of battery cells collectively referred to at 150 and individually identified at 150A, 150B, 150C. The cells 150 have pads or spacers collectively referred to at 160 and individually identified at 160A, 160B, 160C arranged between adjacent cells 150. The cells 150 and spacers 160 can collectively be referred to as a stack 162 that is housed within a module housing 164 for cell containment. While the example shown in FIG. 2 illustrates a spacer 160 disposed between each adjacent cell 150, it will be appreciated that the spacers 160 can be disposed differently such as between every two, three or more cells 150 depending upon design goals.

FIG. 3 is a stress strain plot 168 showing prior art plots including plots 170A, 170C, 170D for various polymer materials used for conventional compression pads. Plot 180 a plot showing an exemplary curve having an extended plateau section 182 resulting from a compression spacer constructed in according to the principles of the present application. Plot 180 results in a stress-strain curve having an extended plateau 182 providing a desirable extended consistent stress over a range of strain. By way of example only, the plot 182 can provide a stress between 1 MPa and 1.5 MPa and a strain between substantially 20% and 50%. Other results can be provided by the examples contained herein to achieve a desired stress-strain relationship depending upon the particular application being designed.

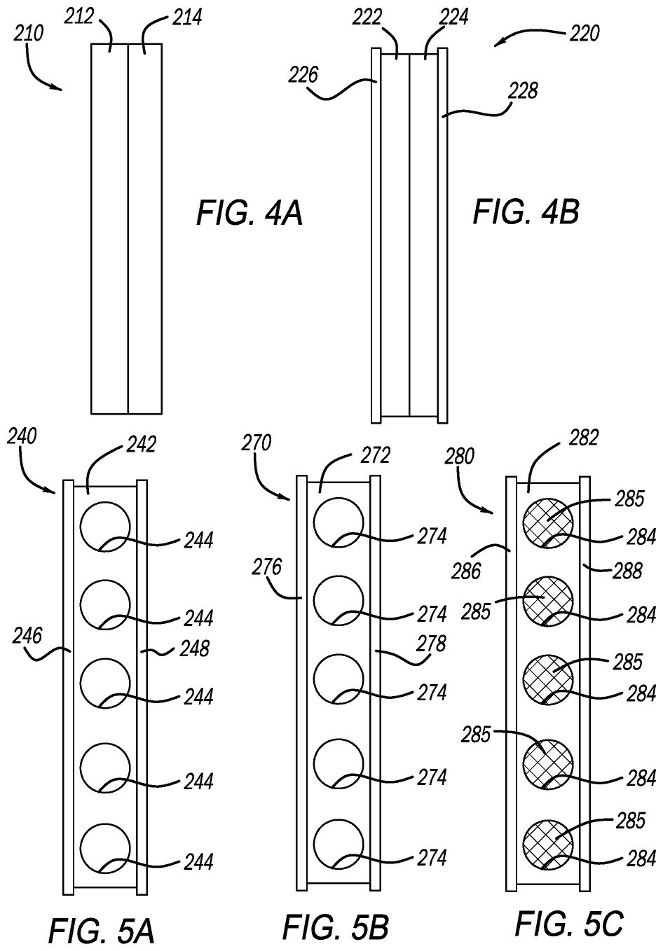

FIG. 4A illustrates a spacer 210 constructed in accordance to one example of the present disclosure. The spacer 210 includes a first layer of material 212 and a second layer of material 214. The first layer of material 212 can be formed of a first material such as a polymer. One non-limiting polymer used for the first layer includes polyurethane or silicone. The second layer of material 214 can be formed of a second material such as a polymer. One non-limiting polymer used for the first layer includes polyurethane or silicone. The first and second layers 212, 214 can have polymers with distinct material properties. By including two distinct materials having different properties, compression characteristics can be achieved according to a particular application as needed. While the spacer 210 is shown and described as having two layers of material 212, 214, additional layers of material having similar or different material properties may be included to achieve a particular stress-strain design goal.

FIG. 4B is a sectional view of an exemplary spacer 220 constructed according to additional principles of the present application. The spacer 220 includes a first layer of material 222 and a second layer of material 224 sandwiched between first and second backing plates 226, 228. The first layer of material 222 can be formed of a first material such as a polymer. One non-limiting polymer used for the first layer includes polyurethane or silicone. The second layer of material 224 can be formed of a second material such as a polymer. One non-limiting polymer used for the first layer includes polyurethane or silicone. The first and second layers of material 222, 224 can have polymers with distinct material properties. The backing plates 226, 228 can be formed of a polymer or alloy material. By including two distinct materials for the first and second layers having different properties, compression characteristics can be achieved according to a particular application as needed. Further, the backing plates 226, 228 can be formed of a material having distinct material properties compared to the first and second layers 222, 224 providing additional modifiable stress-strain characteristics.

FIG. 5A is a sectional view of an exemplary spacer 240 constructed according to additional principles of the present application. The spacer 240 includes a first layer of material 242 having voids or passages 244 formed therein. The passages 244 are formed generally in the shape of a bore. It is appreciated however that some or more of the passages 244 can have other shapes such as ellipses, ovals, triangles, rectangles, octagons, pentagons or combinations thereof. The spacer 240 includes the first layer of material 242 sandwiched between first and second backing plates 246, 248.

The backing plates 246, 248 can be formed of a polymer or alloy material. In one example, the backing plates 246, 248 are formed of a common material as the first layer of material 242. As can be appreciated, during compression of the spacer 240, the spacer 240 can have initial compression characteristics (such as stress-strain characteristics) for a first amount of compression and then (once compression of the around the passages 244 occurs) have other compression characteristics for a second amount of compression.

FIG. 5B is a sectional view of an exemplary spacer 270 constructed according to additional principles of the present application. The spacer 270 includes a first layer of material 272 having voids or passages 274 formed therein. The passages 274 are formed generally in the shape of a bore. It is appreciated however that the passages 274 can have other shapes such as ellipses, ovals, triangles, rectangles, octagons, pentagons or combinations thereof. The spacer 270 includes the first layer of material 272 sandwiched between first and second backing plates 276, 278.

The backing plates 276, 278 can be formed of a polymer or alloy material. In one example, the backing plates 276, 278 are formed of a distinct material as the first layer of material 272. As can be appreciated, during compression of the spacer 270, the spacer 270 can have initial compression characteristics (such as stress-strain characteristics) for a first amount of compression and then (once compression of the around the passages 272 occurs) have other compression characteristics for a second amount of compression.

FIG. 5C is a sectional view of an exemplary spacer 280 constructed according to additional principles of the present application. The spacer 280 includes a first layer of material 282 having voids or passages 284 formed therein. The passages 284 are formed in the shape of a bore. The passages 284 include filler material or members 285 disposed within the respective passages 284. It is appreciated however that the passages 284, and filler 285 can have other shapes such as ellipses, ovals, triangles, rectangles, octagons, pentagons or combinations thereof. The filler 285 can be formed of a polymer having distinct properties as the polymer used for the first layer of material 282. The spacer 280 includes the first layer of material 282 sandwiched between first and second backing plates 286, 288.

The backing plates 286, 288 can be formed of a polymer or alloy material. In one example, the backing plates 286, 288 are formed of a distinct material as the first layer of material 282 and the filler 285. As can be appreciated, during compression of the spacer 280, the spacer 280 can have initial compression characteristics (such as stress-strain characteristics) for a first amount of compression and then (once compression of the filler 285 occurs) have other compression characteristics for a second amount of compression. In other examples, some of the passages 284 can be empty without the filler 285.

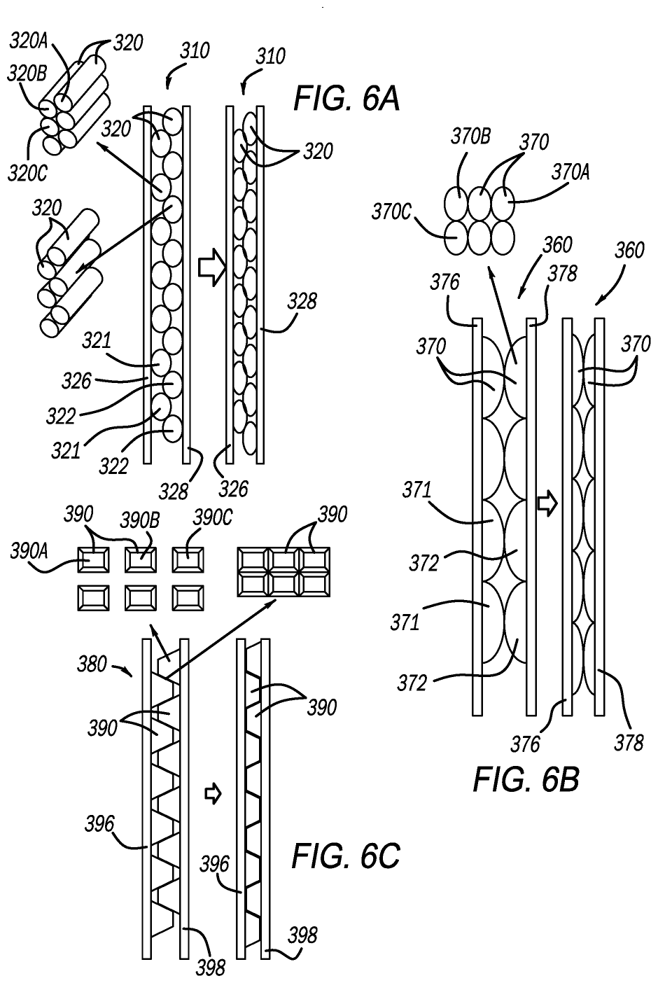

FIG. 6A is a sectional view of an exemplary spacer 310 constructed according to additional principles of the present application. The spacer 310 includes a plurality of first filler members collectively identified at reference 320 and individually identified at 320A, 320B, 320C. The filler members 320 are sandwiched between first and second backing plates 326, 328. The filler members 320 of the spacer 310 are in the general shape of cylinders. The filler members 320 can have other shapes such as ovals, triangles, rectangles, octagons, pentagons or combinations thereof. The filler material 320 can be formed of a polymer.

The backing plates 326, 328 can be formed of a polymer or alloy material. In one example, the backing plates 326, 328 are formed of a distinct material as the filler material 320. As can be appreciated, during compression of the spacer 310, the spacer 310 can have initial compression characteristics (such as stress-strain characteristics) for a first amount of compression and then (once compression of the filler material 320 progresses) have other compression characteristics for a second amount of compression. It is appreciated that the filler material 320 can be arranged in symmetrical or offset configurations to achieve different compression results. The plurality of filler members 320 are arranged in an offset configuration wherein first filler members 321 of a first layer of the plurality of filler members 320 alternatively locate between complementary second filler members 322 of a second layer of the plurality of filler members 320 during compression of the first spacer. More shapes such as hemisphere, oblique cylinder, cone, oblique cubes can be configured to provide variations of elastic material and void space over compressive displacement to achieve desired response according to a particular application.

FIG. 6B is a sectional view of an exemplary spacer 360 constructed according to additional principles of the present application. The spacer 360 includes a plurality of first filler members collectively identified at reference 370 and individually identified at 370A, 370B, 370C. The filler members 370 are sandwiched between first and second backing plates 376, 378. The filler members 370 of the spacer 370 are in the shape of ellipses. The filler members 370 can have other shapes such as ovals, triangles, rectangles, octagons, pentagons or combinations thereof. The filler material 370 can be formed of a polymer.

The backing plates 376, 378 can be formed of a polymer or alloy material. In one example, the backing plates 376, 378 are formed of a distinct material as the filler material 370. As can be appreciated, during compression of the spacer 360, the spacer 360 can have initial compression characteristics (such as stress-strain characteristics) for a first amount of compression and then (once compression of the filler material 370 progresses) have other compression characteristics for a second amount of compression. It is appreciated that the filler material 370 can be arranged in symmetrical or offset configurations to achieve different compression results. The plurality of filler members 370 are arranged in a symmetrical or opposing configuration wherein first filler members 371 of a first layer of the plurality of filler members 370 compress directly against complementary second filler members 372 of a second layer of the plurality of filler members 370 during compression of the first spacer. More shapes such as hemisphere, oblique cylinder, cone, oblique cubes can be configured to provide variations of elastic material and void space over compressive displacement to achieve desired response according to a particular application.

FIG. 6C is a sectional view of an exemplary spacer 380 constructed according to additional principles of the present application. The spacer 380 includes a plurality of first filler members collectively identified at reference 390 and individually identified at 390A, 390B, 390C. The filler members 390 are sandwiched between first and second backing plates 396, 398. The filler members 390 of the spacer 390 are in the shape of trapezoids or square cones. The filler members 390 can have other shapes such as ovals, triangles, rectangles, octagons, pentagons or combinations thereof. The filler material 390 can be formed of a polymer.

The backing plates 396, 398 can be formed of a polymer or alloy material. In one example, the backing plates 396, 398 are formed of a distinct material as the filler material 390. As can be appreciated, during compression of the spacer 380, the spacer 380 can have initial compression characteristics (such as stress-strain characteristics) for a first amount of compression and then (once compression of the filler material 390 progresses) have other compression characteristics for a second amount of compression. It is appreciated that the filler material 370 can be arranged in symmetrical or offset configurations to achieve different compression results. More shapes such as hemisphere, oblique cylinder, cone, oblique cubes can be configured to provide variations of elastic material and void space over compressive displacement to achieve desired response according to a particular application.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A battery module for an electrified vehicle, the battery module comprising:
a first battery cell;
a second battery cell; and
a first spacer disposed intermediate the first and second battery cells, the first spacer comprising:
a first layer of material disposed between a first and second backing plate, the first layer of material defining a plurality of passages formed therein, the plurality of passages defining a first geometric shape, the first layer of material formed of a first polymer; and
a plurality of filler members disposed within the respective plurality of passages, the plurality of filler members defining a second geometric shape, the plurality of filler members formed of a second polymer;
wherein the first and second polymers are distinct.

2. The battery module of claim 1, wherein the first geometric shape comprises a cylindrical bore.

3. The battery module of claim 2, wherein the second geometric shape comprises a cylinder.

4. The battery module of claim 3, wherein the first spacer is configured to compress between the first and second cells whereby a stress-strain curve presents a substantial plateau section.

5. The battery module of claim 4, wherein the substantial plateau section represents a stress substantially between 1 MPa and 1.5 MPa and a strain substantially between 20% and 50%.

6. The battery module of claim 1, wherein at least one of the first and second polymer comprise one of polyurethane and silicone.

7. The battery module of claim 1, wherein the first and second backing plates are formed of a polymer.

8. The battery module of claim 1, wherein the first and second backing plates are formed of an alloy.

9. The battery module of claim 1, wherein the first geometric shape comprises at least one of an ellipse, oval, triangle, rectangle, octagon, pentagon or combinations thereof.

10. A battery module for an electrified vehicle, the battery module comprising:
a first battery cell;
a second battery cell; and
a first spacer disposed intermediate the first and second battery cells, the first spacer comprising:
a plurality of filler members disposed between a first and second backing plate, the plurality of filler members defining a first geometric shape, the plurality of filler members formed of a first polymer.

11. The battery module of claim 10, wherein the plurality of filler members are arranged in an offset configuration wherein first filler members of a first layer of the plurality of filler members alternatively locate between complementary second filler members of a second layer of the plurality of filler members during compression of the first spacer.

12. The battery module of claim 10, wherein the plurality of filler members are arranged in an opposing configuration wherein first filler members of a first layer of the plurality of filler members compress directly against complementary second filler members of a second layer of the plurality of filler members during compression of the first spacer.

13. The battery module of claim 10, wherein the first geometric shape comprises a cylinder.

14. The battery module of claim 10, wherein the first geometric shape comprises an oval.

15. The battery module of claim 10, wherein the first geometric shape comprises a trapezoid.

16. The battery module of claim 10, wherein the first spacer is configured to compress between the first and second cells whereby a stress-strain curve presents a substantial plateau section.

17. The battery module of claim 16, wherein the substantial plateau section represents a stress substantially between 1 MPa and 1.5 MPa and a strain substantially between 20% and 50%.

18. The battery module of claim 10, wherein the first polymer comprises one of polyurethane and silicone.

19. The battery module of claim 10, wherein the first and second backing plates are formed of a polymer.

20. The battery module of claim 10, wherein the first and second backing plates are formed of an alloy.
